(19) United States
(12) Patent Application Publication
(10) Pub. No.: US 2025/0266475 A1
(43) Pub. Date: Aug. 21, 2025

(54) AIR-COOLED FUEL CELL SYSTEM

(71) Applicant: TOYOTA JIDOSHA KABUSHIKI KAISHA, Toyota-shi Aichi-ken (JP)

(72) Inventor: Nobuaki NONOYAMA, Chiryu-shi Aichi-ken (JP)

(73) Assignee: TOYOTA JIDOSHA KABUSHIKI KAISHA, Toyota-shi Aichi-ken (JP)

(21) Appl. No.: 19/049,029

(22) Filed: Feb. 10, 2025

(30) Foreign Application Priority Data
Feb. 20, 2024 (JP) 2024-023571

(51) Int. Cl. H01M 8/04119; H01M 8/04014; H01M 8/04082; H01M 8/10; H01M 8/2483

(52) U.S. Cl. CPC H01M 8/04156; H01M 8/04014; H01M 8/04201; H01M 8/2483; H01M 2008/1095

(57) ABSTRACT

A fuel cell system capable of efficiently drain water and reducing the amount of water in exhaust gas, the fuel cell system includes a case and a fuel cell stack; the case houses the fuel cell stack; wherein the fuel cell stack is a stack of unit cells; wherein the unit cells are stacked at an angle of from 10° to 80° with respect to the horizontal direction; the fuel cell stack comprises a reaction air inlet manifold, a reaction air outlet manifold, a hydrogen inlet manifold and a hydrogen outlet manifold; the hydrogen inlet manifold is disposed above the hydrogen outlet manifold in the gravitational force direction; and wherein the reaction air inlet manifold is disposed above the reaction air outlet manifold in the gravitational force direction.

### CROSS-REFERENCE TO RELATED APPLICATIONS

This application is based upon and claims the benefit of priority of the prior Japanese Patent Application No. 2024-023571, filed on Feb. 20, 2024, the entire contents of which are incorporated herein by reference.

### TECHNICAL FIELD

The disclosure relates to an air-cooled fuel cell system.

### BACKGROUND

Various studies have been proposed for a fuel cell (FC) as disclosed in Patent Document 1.

Patent Document 1: Japanese Patent Application Laid-Open (JP-A) No. 2016-046852

Patent Document 1 discloses that an air-cooled fuel cell is tilted and mounted on a two-wheel vehicle. An open-type air-cooled fuel cell which is supposed to be mounted on a vehicle such as a two-wheel vehicle, has been studied. In the case of an open-type fuel cell, water is sprayed around the fuel cell by drainage.

### SUMMARY

The disclosure was achieved in light of the above circumstances. An object of the disclosure is to provide an air-cooled fuel cell system configured to efficiently drain water and reducing the amount of water in exhaust gas.

That is, the present disclosure includes the following embodiments.
21 1> An air-cooled fuel cell system,

wherein the fuel cell system comprises a case and a fuel cell stack;

wherein the case houses the fuel cell stack;

wherein the fuel cell stack is a stack of unit cells;

wherein the unit cells are stacked at an angle of from 10° to 80° with respect to the horizontal direction;

wherein the fuel cell stack comprises a reaction air inlet manifold, a reaction air outlet manifold, a hydrogen inlet manifold and a hydrogen outlet manifold;

wherein the hydrogen inlet manifold is disposed above the hydrogen outlet manifold in the gravitational force direction; and

wherein the reaction air inlet manifold is disposed above the reaction air outlet manifold in the gravitational force direction.
<2>The air-cooled fuel cell system according to <1>,

wherein each of the unit cells comprises a reaction air flow path, a hydrogen flow path, and a cooling air flow path;

wherein, in a plan view of each unit cell, the cooling air flow path intersects the reaction air flow path and the hydrogen flow path;

wherein an outlet side of the cooling air flow path is disposed above an inlet side of the cooling air flow path in the gravitational force direction;

wherein, in a plan view of the fuel cell stack, the hydrogen outlet manifold and the reaction air outlet manifold are disposed on the inlet side of the cooling air flow path; and

wherein, in the plan view of the fuel cell stack, the hydrogen inlet manifold and the reaction air inlet manifold are disposed on the outlet side of the cooling air flow path.
<3>The air-cooled fuel cell system according to <1>or <2>,

wherein the fuel cell system comprises an exhaust port, and

wherein the fuel cell system further comprises a gas-liquid separator between the hydrogen outlet manifold and the exhaust port and between the reaction air outlet manifold and the exhaust port.

The fuel cell system of the present disclosure is configured to efficiently drain water and reducing the amount of water in the exhaust gas.

### BRIEF DESCRIPTION OF THE DRAWINGS

In the accompanying drawings,

FIG. 1 is a schematic exploded perspective view of an example of the unit fuel cell included in the fuel cell system of the present disclosure;

FIG. 2 is a schematic view of an example of the arrangement of the fuel cell stack included in the fuel cell system of the present disclosure;

FIG. 3 is a schematic plan view of an example of the hydrogen flow path and cooling air flow path of the unit cell included in the fuel cell system of the present disclosure;

FIG. 4 is a schematic plan view of an example of the reaction air flow path and cooling air flow path of the unit cell included in the fuel cell system of the present disclosure;

FIG. 5 is a system configuration diagram illustrating an example of the fuel cell system of the present disclosure; and

FIG. 6 is a system configuration diagram illustrating another example of the fuel cell system of the present disclosure.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

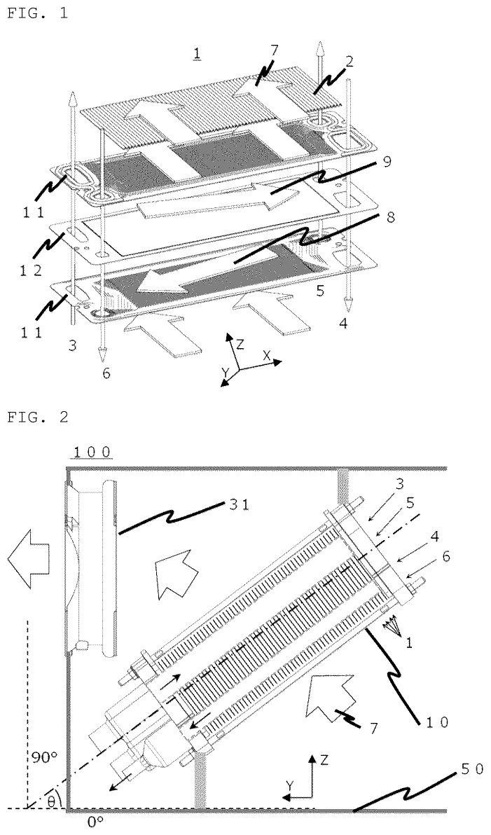

In addition, dimensional relationships (length, width, thickness, and the like) in the drawings do not reflect actual dimensional relationships. FIGS. 1-4 also show the direction of the three-dimensional Cartesian coordinate system. Here, it is assumed that xy plane is a horizontal plane, the z-axis direction is a vertical direction, and the larger in the z-axis direction is the upper.

In the present disclosure, a gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidant gas is a gas containing oxygen, and may be oxygen, air, or the like. In the present disclosure, air as an oxidant gas is referred to as reaction air, and air as a cooling gas is referred to as cooling air.

In the present disclosure, there is provided an air-cooled fuel cell system,

wherein the fuel cell system comprises a case and a fuel cell stack;

wherein the case houses the fuel cell stack;

wherein the fuel cell stack is a stack of unit cells;

wherein the unit cells are stacked at an angle of from 10° to 80° with respect to the horizontal direction;

wherein the fuel cell stack comprises a reaction air inlet manifold, a reaction air outlet manifold, a hydrogen inlet manifold and a hydrogen outlet manifold;

wherein the hydrogen inlet manifold is disposed above the hydrogen outlet manifold in the gravitational force direction; and

wherein the reaction air inlet manifold is disposed above the reaction air outlet manifold in the gravitational force direction.

If the drainage from the fuel cell is not smooth, water pools or freeze-clogging may occur in the unit cell, manifold, and piping, resulting in a malfunction of the fuel cell.

When a large amount of moisture is contained in the exhaust gas, water is sprayed to the outside of the fuel cell system, and the walls and floors around the fuel cell system become wet, and dew condensation is generated, which deteriorates the environment around the fuel cell system.

In the present disclosure, by inclining the air-cooled fuel cell, the water management is improved, and the failure of the power generation function of the fuel cell and the scattering of water to the outside of the fuel cell system are prevented.

The fuel cell system includes a case and a fuel cell stack.

The fuel cell system may include a hydrogen system, a reaction air system, and a cooling air system.

The case houses the fuel cell stack.

The case may have an intake port and an exhaust port of a cooling air system.

The fuel cell stack is a stacked body in which a plurality of unit cells are stacked.

In the present disclosure, both the unit cell and the fuel cell stack may be referred to as a fuel cell.

In a fuel cell, hydrogen and air react to generate electricity.

The number of stacked unit cells in the fuel cell stack is not particularly limited, and may be, for example, 2 to several hundred.

The fuel cell stack may include a current collector plate, a pressure plate, and the like at an end portion in the stacking direction.

In the case, the unit cells are stacked at an angle of from 10° to 80° with respect to the horizontal direction. As a result, the drainage in the manifold can be accelerated by gravity.

The lower limit of the inclination angle of the plurality of unit cells with respect to the horizontal direction may be 10° or more, and may be 20° or more. The upper limit of the inclination angle of the plurality of unit cells with respect to the horizontal direction may be 80° or less, and may be 70° or less. When the inclination angle is less than 10° or more than 80°, water tends to accumulate in the manifold, and there is a possibility that the manifold is blocked by freezing of the water. Further, in order to discharge water, it is necessary to increase the flow rate of the gas, and the power generation efficiency of the fuel cell is lowered.

The fuel cell stack includes a reaction air inlet manifold, a reaction air outlet manifold, a hydrogen inlet manifold, and a hydrogen outlet manifold.

The hydrogen inlet manifold is positioned above the hydrogen outlet manifold in the gravitational force direction. This allows drainage along gravity in the hydrogen manifold.

The reaction air inlet manifold is positioned above the reaction air outlet manifold in the gravitational force direction. This allows drainage along gravity in the reaction air manifold.

The unit cell may have a reaction air flow path (oxidant gas flow path), a hydrogen flow path (fuel gas flow path), and a cooling air flow path (cooling gas flow path).

In a plan view of the unit cell, the cooling air flow path may intersect the reaction air flow path. In a plan view of the unit cell, the cooling air flow path may intersect the hydrogen flow path.

The outlet side of the cooling air flow path may be positioned above the inlet side of the cooling air flow path in the gravity direction.

In a plan view of the fuel cell stack, the hydrogen outlet manifold and the reaction air outlet manifold may be disposed on the inlet side of the cooling air flow path.

In a plan view of the fuel cell stack, the hydrogen inlet manifold and the reaction air inlet manifold may be disposed on the outlet side of the cooling air flow path.

The hydrogen outlet manifold and the reaction air outlet manifold are disposed on the inlet side, which is the cold side of the cooling air flow path, and the hydrogen inlet manifold and the reaction air inlet manifold are disposed on the cooling air outlet side, which is the hot side of the cooling air flow path. As a result, the outlet side of the cooling air flow path of each unit cell is positioned above the inlet side, and the exhaust heat of each unit cell can be discharged by the natural convection of the cooling air, so that the cooling of each unit cell can be promoted. By arranging the hydrogen outlet manifold and the reaction air outlet manifold on the inlet side of the cooling air flow path, the water vapor can be efficiently liquefied, the amount of water contained in the exhaust gas can be reduced, and the dew point of the exhaust gas can be lowered. In each of the tilted manifolds, the droplets are discharged out of the fuel cell along gravity.

The unit cell may have a flow path structure for flowing the reaction air and the cooling air so that the flow of the cooling air and the flow of the reaction air cross each other in a plan view. The flow of cooling air and the flow of reaction air may intersect or be orthogonal. In a plan view of the unit cell, the flow of hydrogen and the flow of reaction air may cross or be orthogonal to each other.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are an anode (fuel electrode or hydrogen electrode) and a cathode (oxygen electrode or air electrode).

The electrode includes a catalytic layer, and may optionally include a gas diffusion layer, and the power generation unit may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each catalyst layer, a support (catalyst-supported support) on which a catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell of the fuel cell may include a separator.

The separator collects current generated by power generation and functions as a partition wall. In the unit cell of the fuel cell, the separators are usually arranged on both sides in the stacking direction of the power generation unit such that a pair of separators sandwich the power generation unit. One of the pair of separators is an anode separator and the other is a cathode separator.

The anode separator may have a groove that serves as a hydrogen gas flow path on a surface on the side of the power generation unit.

The cathode separator may have a groove that serves as a reaction air flow path on a surface on the side of the power generation unit.

The separator may have holes constituting a manifold such as a supply hole and a discharge hole for allowing fluid to flow in the stacking direction of the unit cell.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be a three-layer sheet composed of three layers in which an adhesive layer is disposed on a surface layer. The unit cell may have a corrugated cooling fin serving as a cooling air flow path.

The fuel cell system may include a control device. The control device may control the entire fuel cell system by controlling the reaction air system, the hydrogen system, the cooling air system, and the like.

The control device physically includes, for example, an arithmetic processing unit such as a CPU (central processing unit), a ROM (read-only memory) that stores control programs and control data to be processed by CPU, a storage device such as a RAM (random access memory) that is mainly used as various working areas for the control processing, and an input/output interface, and may be a ECU (electronic control unit).

The hydrogen system supplies hydrogen as a fuel gas to the fuel cell and adjusts the flow rate of the hydrogen. The hydrogen system may have a circulation system that circulates hydrogen supplied to the fuel cell. The hydrogen system includes a hydrogen tank, a hydrogen inlet valve, an injector, a hydrogen purge valve, a hydrogen pipe, and the like, and the hydrogen system may include, as a circulation system, a gas-liquid separator, a hydrogen pump, an ejector, a hydrogen circulation pipe, and the like. The hydrogen circulation pipe connects the gas-liquid separator, the hydrogen pump, and the ejector in this order from the hydrogen outlet of the fuel cell to the hydrogen inlet of the fuel cell, thereby enabling hydrogen circulation.

The hydrogen system may include an exhaust port for exhausting the hydrogen off-gas to the outside of the fuel cell system.

The reaction air system supplies reaction air as an oxidant gas to the fuel cell and regulates a flow rate of the reaction air.

The reaction air system may have an inlet-side sealing valve at the inlet of the reaction air of the fuel cell and an outlet-side sealing valve at the outlet of the reaction air of the fuel cell.

The reaction air system may have a reaction air inlet and a reaction air blowing device. A pressure loss body (an air filter or the like) may be installed in the reaction air intake port.

The reaction air blowing device may be an air compressor, an air pump, an air blower, an air fan, or the like.

The reaction air system may include an exhaust port for exhausting the reaction air off-gas to the outside of the fuel cell system.

The cooling air system supplies cooling air as a cooling gas to the fuel cell and regulates a flow rate of the cooling air.

The cooling air system may comprise cooling air blowing device for generating a flow of cooling air. The cooling air system may have an intake port for taking air from the outside. A pressure loss body (an air filter or the like) may be installed in the intake port.

The cooling air blowing device may be an air compressor, an air pump, an air blower, an air fan, or the like.

The fuel cell system may include an exhaust port that exhausts gas to the outside of the fuel cell system.

The fuel cell system may include a gas-liquid separator between the hydrogen outlet manifold and the exhaust port and between the reaction air outlet manifold and the exhaust port.

The fuel cell system may include a gas-liquid separation unit downstream of the outlet side sealing valve of the reaction air system and downstream of the hydrogen purge valve of the hydrogen system.

The exhaust gas passes through the gas-liquid separation unit and becomes an exhaust gas having a low dew point from which the liquid droplets are separated. This makes it possible to prevent dew condensation and water clogging in the downstream side of the exhaust pipe.

In the case of a fuel cell system including a hydrogen circulation system, it is possible to prevent water clogging in a hydrogen circulation pipe or a unit cell. When the hydrogen outlet manifold is disposed on the inlet side, which is the low temperature side of the cooling air flow path, the dew point of the circulating gas becomes low, and the hydrogen inlet manifold is disposed on the high temperature side of the cooling air flow path, so that condensation hardly occurs.

When a gas containing a large amount of moisture is discharged to the outside of the fuel cell system, the outside periphery of the fuel cell system is wetted, but it is possible to prevent the outside periphery of the fuel cell system from being wetted by using the exhaust gas having a reduced dew point.

The gas-liquid separation unit may have a gas-liquid separation function.

The gas-liquid separation unit may be a water storage tank that stores liquid water, or may separate the gas-liquid by using an upper space of the water storage tank. The gas-liquid separated liquid water is collected in a water storage tank to prevent the liquid water from flowing out of the fuel cell system. The water storage tank may be provided with a drain valve.

The gas-liquid separation unit may be a hose or may be continuously drained to the drain port by the hose.

The gas-liquid separation unit may be a simple T-pipe.

FIG. 1 is a schematic exploded perspective view of an example of the unit fuel cell included in the fuel cell system of the present disclosure.

The unit cell 1 shown in FIG. 1 includes a cooling fin (cooling air flow path) 2 serving as a flow path for cooling air (cooling gas) 7, a reaction air inlet manifold 3, a reaction air outlet manifold 4, a hydrogen inlet manifold 5, a hydrogen outlet manifold 6, two separators 11, and a MEA and a resin frame 12 sandwiched between the two separators 11. As shown in FIG. 1, the unit cell 1 of the fuel cell has a flow path structure in which the reaction air 9 and the cooling air 7 are independent from each other. The hydrogen 8 and the reaction air 9 are counter-current.

FIG. 2 is a schematic view of an example of the arrangement of the fuel cell stack included in the fuel cell system of the present disclosure.

The fuel cell system 100 shown in FIG. 2 includes a case 50 and a cooling fan 31, and the fuel cell stack 10 is housed in the case 50.

The fuel cell stack 10 is a stacked body in which a plurality of unit cells 1 are stacked.

In the case 50, the plurality of unit cells 1 (fuel cell stack 10) are disposed to be inclined by θ° with respect to the horizontal direction.

The fuel cell stack 10 has a reaction air inlet manifold 3, a reaction air outlet manifold 4, a hydrogen inlet manifold 5, and a hydrogen outlet manifold 6.

The hydrogen inlet manifold 5 is positioned above the hydrogen outlet manifold 6 in the gravitational force direction.

The reaction air inlet manifold 3 is disposed above the reaction air outlet manifold 4 in the gravitational force direction.

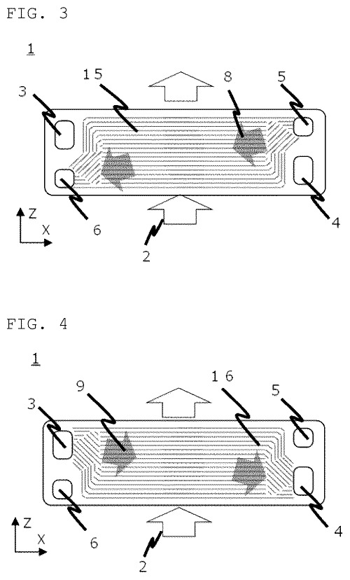

FIG. 3 is a schematic plan view of an example of the hydrogen flow path and cooling air flow path of the unit cell included in the fuel cell system of the present disclosure.

In the unit cell 1 shown in FIG. 3, the cooling air flow path 2 intersects the hydrogen flow path 15 in a plan view.

The outlet side of the cooling air flow path 2 is positioned above the inlet side of the cooling air flow path 2 in the gravity direction.

In a plan view of the unit cell 1 (and the fuel cell stack 10), the hydrogen outlet manifold 6 is disposed on the inlet side of the cooling air flow path 2.

In a plan view of the unit cell 1 (and the fuel cell stack 10), the hydrogen inlet manifold 5 is disposed on the outlet side of the cooling air flow path 2.

FIG. 4 is a schematic plan view of an example of the reaction air flow path and cooling air flow path of the unit cell included in the fuel cell system of the present disclosure.

In the unit cell 1 shown in FIG. 4, the cooling air flow path 2 intersects the reaction air flow path 16 in a plan view.

The outlet side of the cooling air flow path 2 is positioned above the inlet side of the cooling air flow path 2 in the gravity direction.

In a plan view of the unit cell 1 (and the fuel cell stack 10), the reaction air outlet manifold 4 is disposed on the inlet side of the cooling air flow path 2.

In a plan view of the unit cell 1 (and the fuel cell stack 10), the reaction air inlet manifold 3 is disposed on the outlet side of the cooling air flow path 2.

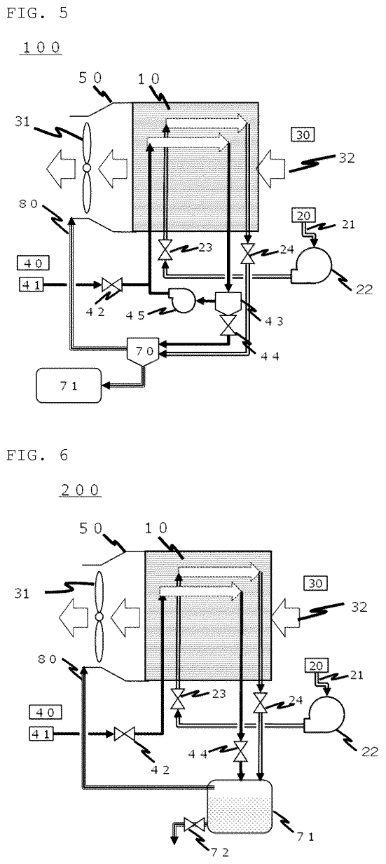

FIG. 5 is a system configuration diagram illustrating an example of the fuel cell system of the present disclosure.

The fuel cell system 100 illustrated in FIG. 5 includes a case 50, a fuel cell stack 10, a reaction air system 20, a cooling air system 30, and a hydrogen system 40.

The reaction air system 20 includes a reaction air intake port 21, an air blower 22, an inlet-side sealing valve 23, and an outlet-side sealing valve 24. The reaction air inlet 21 may include an air filter.

The cooling air system 30 includes a cooling fan 31 and an intake port 32. The intake port 32 may include an air filter.

The hydrogen system 40 includes a hydrogen tank 41, a hydrogen inlet valve 42, a gas-liquid separator 43, a hydrogen purge valve 44, and a hydrogen pump 45.

The fuel cell system 100 includes air blower 22, and cooling fan 31 independent of the reaction air system 20 and the cooling air system 30.

The fuel cell system 100 includes an exhaust port 80 that exhausts gas to the outside of the fuel cell system 100.

The fuel cell system 100 includes a second gas-liquid separator (gas-liquid separator) 70 downstream of the outlet-side sealing valve 24 of the reaction air system 20 and the hydrogen purge valve 44 of the hydrogen system 40, and a water storage tank 71 for storing the separated liquid water downstream of the second gas-liquid separator 70.

FIG. 6 is a system configuration diagram illustrating another example of the fuel cell system of the present disclosure.

In FIG. 6, the same components as those in FIG. 5 are denoted by the same reference numerals, and description thereof will be omitted.

The fuel cell system 200 illustrated in FIG. 6 does not include the gas-liquid separator 43, the second gas-liquid separator (gas-liquid separator) 70, and the hydrogen pump 45 as compared with the fuel cell system 100. The water storage tank 71 has a drain valve 72 that drains the outer liquid water to the outside of the fuel cell system 200. A drain port may be provided downstream of the drain valve 72.

### REFERENCE SIGNS LIST

1. Unit cell
2. Cooling fins (cooling air flow path)
3. Reaction air inlet manifold
4. Reaction air outlet manifold
5. Hydrogen inlet manifold
6. Hydrogen outlet manifold
7. Cooling air (cooling gas)
8. Hydrogen gas
9. Reaction air
10. Fuel cell stack
11. Separator
12. MEA, resin frame
15. Hydrogen flow path
16. Reaction air flow path
20. Reactive air system
21. Reaction air inlet
22. Air blower
23. Inlet side sealing valve
24. Outlet side sealing valve
30. Cooling air system
31. Cooling fan
32. Air inlet
40. Hydrogen system
41. Hydrogen tank
42. Hydrogen inlet valve
43. Gas separator
44. Hydrogen purge valve
45. Hydrogen pump
50. Case
70. Second gas-liquid separator
71. Water storage tank
72. Drain valve
80. Exhaust port
100. Fuel cell system
200. Fuel cell system

1. An air-cooled fuel cell system,
wherein the fuel cell system comprises a case and a fuel cell stack;
wherein the case houses the fuel cell stack;
wherein the fuel cell stack is a stack of unit cells;
wherein the unit cells are stacked at an angle of from 10° to 80° with respect to a horizontal direction;
wherein the fuel cell stack comprises a reaction air inlet manifold, a reaction air outlet manifold, a hydrogen inlet manifold and a hydrogen outlet manifold;
wherein the hydrogen inlet manifold is disposed above the hydrogen outlet manifold in a gravitational force direction; and
wherein the reaction air inlet manifold is disposed above the reaction air outlet manifold in the gravitational force direction.

2. The fuel cell system according to claim 1,
wherein each of the unit cells comprises a reaction air flow path, a hydrogen flow path and a cooling air flow path;
wherein, in a plan view of each unit cell, the cooling air flow path intersects the reaction air flow path and the hydrogen flow path;
wherein an outlet side of the cooling air flow path is disposed above an inlet side of the cooling air flow path in the gravitational force direction;
wherein, in a plan view of the fuel cell stack, the hydrogen outlet manifold and the reaction air outlet manifold are disposed on the inlet side of the cooling air flow path; and
wherein, in the plan view of the fuel cell stack, the hydrogen inlet manifold and the reaction air inlet manifold are disposed on the outlet side of the cooling air flow path.

3. The fuel cell system according to claim 1,
wherein the fuel cell system comprises an exhaust port, and
wherein the fuel cell system further comprises a gas-liquid separator between the hydrogen outlet manifold and the exhaust port and between the reaction air outlet manifold and the exhaust port.
